(19) United States
(12) Patent Application Publication
(10) Pub. No.: US 2005/0150375 A1
(43) Pub. Date: Jul. 14, 2005

(54) Hydraulic rotory actuator with sealing ring

(76) Inventor: Thomas Paa, Hetzmannsdorf (DE)

Correspondence Address: POSZ LAW GROUP, PLC, 12040 SOUTH LAKES DRIVE, SUITE 101, RESTON, VA, 20191, US

(21) Appl. No.: 10/963,776

(22) Filed: Oct. 14, 2004

(30) Foreign Application Priority Data
Oct. 15, 2003 (DE) 20315873.3

(51) Int. Cl. F16J 15/18

(52) U.S. Cl. 92/165 R

(57) ABSTRACT

A hydraulic torque motor for civil engineering machines comprises a housing and a shaft rotatably mounted in said housing, wherein between housing and shaft at each of the two ends of said shaft one respective annular seal of an elastic material is received in a radial opening in said housing and/or in said shaft and compressed in the assembled condition, so that said shaft is mounted in said housing in a fluid-tight manner. One respective mechanical face seal is arranged axially on the outside next to each of said two annular seals and comprises two metallic slide rings and two elastically deformable O-ring seals, which are compressed in the assembled condition so as to axially and/or radially urge said slide rings towards each other and towards said housing or said shaft, with said mechanical face seal thus sealing said associated annular seal against an external environment.

The present invention relates to a hydraulic torque motor for civil engineering machines.

Hydraulic torque motors are robust against impulse-type forces and are therefore utilized in civil engineering machines as actuators, particularly for moving a work tool such as, e.g., a dipper shovel or a clamshell, relative to a handle or arm of the civil engineering machine, or two arms relative to each other.

To this end, for instance, the housing of the hydraulic torque motor is fastened to the arm of the civil engineering machine, and the shaft of the torque motor is fastened, directly or through the intermediary of a quick-change attachment, to a work tool such as a dipper shovel, as described in EP 0 703 321 B1 which is herewith fully incorporated into the disclosure of the present invention by way of reference. The inverse construction, i.e., a connection of the torque motor shaft with the arm, and of the torque motor housing with the work tool, is also possible.

In the case of such a hydraulic torque motor, the shaft thereof is mounted in a fluid-tight manner and rotatably in the housing. In order to seal the work fluid that is subjected to high fluctuating pressures, the housing or the shaft includes a radial recess having an elastically deformable annular seal inserted therein. In the assembled condition, this annular seal is compressed between housing and shaft to thereby seal the radial gap between the two components.

During use of the civil engineering machine, the hydraulic torque motor is also subjected to abrasive substances, sand, microscopically fine mud, and the like. Such environmental conditions damage the elastic annular seal and lead to failure of the seal and thus of the torque motor.

In order to solve this problem, it is known to provide a stripper externally in the axial direction, i.e., facing the environment. This stripper also comprises an elastically deformable ring which is received in a radial recess of the housing or of the shaft and compressed in the assembled condition. The stripper differs from the above described annular seal in its material and the lower degree of compression, for it need not resist the high work fluid pressure but only the substances (mud etc.) attacking from outside.

Such strippers do, however, wear relatively rapidly due to the aggressive environmental conditions they are exposed to—within a few weeks to years depending on application—and must then be replaced for a continued protection of the annular seal. In every instance this results in immobilization of the civil engineering machine, removal and reassembly of the torque motor, and replacement of the stripper.

It is therefore an object of the present invention to furnish a hydraulic torque motor for civil engineering machines that avoids the above described drawbacks.

This object is attained through the subject matter of claim 1.

A hydraulic torque motor for civil engineering machines in accordance with the invention comprises, in a manner known per se, a housing and a shaft rotatably mounted in this housing, wherein between housing and shaft at each of the two ends of the shaft one respective annular seal of an elastic material is received in a radial recess in the housing and/or in the shaft and compressed in the assembled condition, so that the shaft is mounted in the housing in a fluid-tight manner.

Axially on the outside next to each of the two annular seals one respective mechanical face seal is arranged, comprising two metallic slide rings and two elastically deformable O-ring seals which are compressed in the assembled condition so as to axially and/or radially urge the slide rings towards each other, with the mechanical face seal thus sealing the associated annular seal against the external environment.

As in floating ring seals the metallic slide rings slide on each other, whereas the elastically compressed O-ring seals are fixed relative to the respective slide ring and to the reception in the housing or shaft, wear to this seal is extremely low, so that it has to be replaced substantially less frequently, ideally never (so-called lifetime seal), whereby undesirable down times of the civil engineering machine for replacing the seals are reduced or even avoided altogether. Nevertheless the work fluid-tight annular seal is sufficiently protected against aggressive environmental conditions such as abrasive substances, microscopically fine mud, etc.

It was surprisingly found that floating ring seals, that are known per se and hitherto were predominantly used with only one sense of rotation in continuous-rotation operation owing to microscopically small movements of the O-ring seals in cases of alternating senses of rotation and owing to the relatively high static friction, may also be used in hydraulic torque motors for civil engineering machines where the rotational velocity is relatively low, full rotations do not occur, the sense of rotation frequently changes, and many start-up operations involving adhesion/sliding transitions of the seals take place.

In a first preferred embodiment of the present invention, the shaft of the torque motor includes two flanges fastened to its ends in a preferably releasable manner, which flanges may advantageously be part of a quick-change attachment or of a work tool thus attached to the shaft of the torque motor. Each flange includes a conical opening radially widening in a direction towards the housing of the torque motor. In a symmetrical configuration the housing also includes at the location opposite to this opening a conical opening widening in a direction towards the said flange of the shaft.

These two conical openings each receive one elastic O-ring seal of a mechanical face seal. Radially on the inside next to each O-ring seal an associated metallic slide ring is arranged, the outer peripheral surface of which facing the O-ring seal has a conical configuration similarly to the opening, and which has a crown-type sliding surface on its other end face facing the other slide ring.

In the assembled condition, the radial spacing between the inner peripheral surface of the conical opening in the housing or flange and the outer peripheral surface of the slide ring is smaller than the radial wall thickness of the non-deformed O-ring seal, so that the latter is compressed to urge the slide ring in a radially inward direction and in an axial direction against the opposite slide ring. Depending on an inclination of the conical opening or outer peripheral surface, respectively, the urging force may act more strongly in either the axial or radial direction, whereby the seat of the mechanical face seal in the reception of the housing or flange and the contact pressure of the sliding surfaces may be adjusted appropriately. As a special case, the inclination of the conical surfaces may even be 90 degrees, i.e., the outer peripheral surfaces of the slide rings are perpendicular relative to the axis of rotation, and the compressive force acts fully in the axial direction.

When the work tool or the quick-change attachment is to be removed from the shaft and some other work tool or some other quick-change attachment is to be fastened thereto, the mechanical face seal must be installed anew in the case of the first embodiment. Nevertheless the installation times required for this are shorter than the down times incurred in regular intervals for exchanging conventional strippers.

In a second preferred embodiment, the shaft comprises at each of its two ends one respective opening receiving an O-ring seal. Radially on the outside next to this O-ring seal a first slide ring is arranged which has a sliding surface at its radial outer peripheral surface. In a radially symmetrical configuration, a second slide ring and a second O-ring seal are arranged in an opening in the housing, with both O-ring seals being compressed and urging the slide rings against each other in a radial direction in the assembled condition.

Further objects, features and advantages of the present invention become apparent from the subclaims and from the practical examples described hereinbelow, wherein:

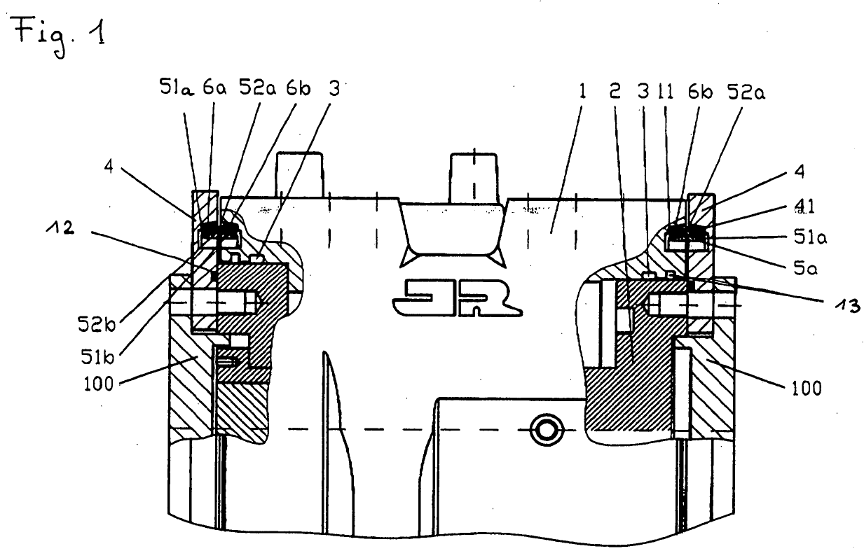

FIG. 1 shows a hydraulic torque motor according to the first embodiment in a partially sectional view; and

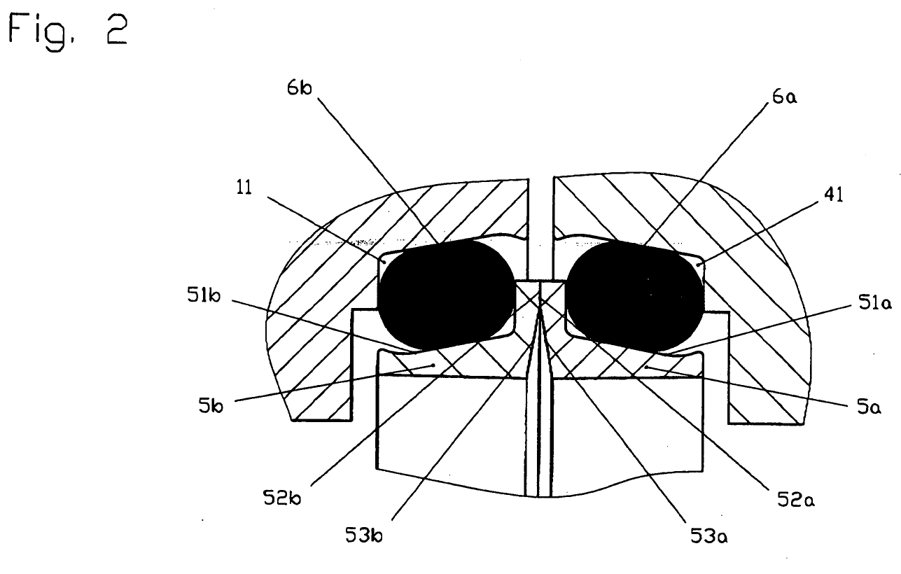

FIG. 2 shows an enlarged representation of a mechanical face seal of FIG. 1.

The hydraulic torque motor comprises a housing 1 and a shaft 2 rotatably mounted in the housing.

In respective radial openings at both ends of the shaft one annular seal 3 each is received in the housing 1 so as to be compressed in the assembled condition presently represented, and thus seals the cavity formed by the housing and by the shaft against the environment, so that there is no leakage of work fluid between housing and shaft.

The shaft 2 has at its two end faces flanges 4 fastened by means of bolts (not represented), through the intermediary of which a work tool or a quick-change attachment (not represented) is attached to the shaft 2. The flanges 4 may be designed to be integral or, in turn, adapted to be connected with the work tool or quick-change attachment, respectively. By means of the same bolts a mounting cap 100 is moreover fastened to the shaft.

Each flange has on its side facing the housing a conical opening 41 radially widening in a direction towards the housing. In this opening a first slide ring 5a is arranged which has an outer peripheral surface 51a conically widening in a direction towards the housing, and an adjacent sliding surface 52a which faces the housing and which is arranged perpendicular to the axis of rotation. Between the inner peripheral surface of the opening 41 and the outer peripheral surface 51a of the slide ring 5a, a first elastic O-ring seal 6a, for example of rubber or the like, is received such as to be compressed in the assembled condition and, as a result of the conical surfaces 41 and 51a on which it is supported, generates a force between flange and slide ring in a radially inward direction and in an axial direction towards the housing.

In an axially symmetrical configuration, the housing 1 has a conical opening 11 radially widening in an outward direction. In this opening a second slide ring 5b is arranged which has an outer peripheral surface 51b conically widening in an outward direction and an outwardly adjacent sliding surface 52b. Between the inner peripheral surface of the opening 11 and the outer peripheral surface 51b a second O-ring seal 6b is received so as to be compressed in the assembled condition and, owing to the conical surfaces on which it is supported, generate a force in a radially inward direction and in an axially outward direction between flange and slide ring. Advantageously the openings 11 and 41 in housing and flange, the slide rings 5a and 5b, and the O-ring seals 6a and 6b have an axially symmetrical configuration.

As a result, the two slide rings 5a and 5b facing each other are in pressurized contact at their sliding surfaces 52a, 52b and thus seal the seal ring 3 against the environment, particularly against abrasive substances, microscopically fine mud, or the like.

When the shaft 2 rotates in the housing 1, the respective sliding surfaces 52a and 52b of the slide rings 5a and 5b slide on each other. As both slide rings are made of metal, for instance of chill casting or roller bearing steel, the sliding surfaces are hardly susceptible to wear. Moreover both slide rings are automatically readjusted upon wear thanks to the axial components of the elastic urging forces. To this end, the sliding surfaces 52a, 52b have radially on the inside respective conical regions 53a and 53b as visible in FIG. 2. If the sliding surfaces 52a and 52b, which have an orientation perpendicular to the axis of rotation, are worn down by wear in an axial direction, the axial spacing between the conical regions 53a, 53b allows for readjustment of the seal by the axial component of the compression forces of the deformed O-ring seals 6a, 6b.

Permanently identical sealing is hereby ensured.

For additional sealing, further sealing elements may be provided singly or in combination as shown in FIG. 1: by way of example, an O-ring 12 is shown here to be arranged in a corresponding annular recess in the end face of each flange 4 facing the shaft 2, so as to be compressed by the adjacent end face of the shaft 2 and thus radially seal the space between the mutually facing surfaces of flange 4 and shaft 2. This i.a. prevents substances from the environment from penetrating radially from inside (e.g., via the mounting cap 100) between flange and shaft and finally to the annular seal 3 to damage the latter. As a relative movement does not occur here, an O-ring or the like is sufficient for this purpose.

On the other hand, axially on the outside next to each annular seal 3 a conventional stripper 13 is received in a radial recess of the housing. This stripper serves, i.a., as a second backup seal on top of the mechanical face seal in case the latter fails or is not provided with a replacement work tool or has to be replaced on-site, so that abrasive substances or the like will not damage the annular seal 3 in the meantime. As the mechanical face seal in accordance with the invention keeps the abrasive substances away both from the annular seal 3 and from the stripper 13, the service life of the stripper 13 is prolonged in comparison with conventional constructions. For the same purpose, the contact pressure of the stripper may furthermore be reduced.

1. Hydraulic torque motor for civil engineering machines, comprising:
a housing (1);
a shaft (2) rotatably mounted in said housing;
wherein between housing and shaft at each of the two ends of said shaft one respective annular seal (3) of an elastic material is received in a radial opening in said housing and/or in said shaft and compressed in the assembled condition, so that said shaft is mounted in said housing in a fluid-tight manner;
characterized in that
axially on the outside next to each of said two annular seals one respective mechanical face seal is arranged, comprising
two metallic slide rings (5a, 5b); and
two elastically deformable O-ring seals (6a, 6b),
which are compressed in the assembled condition so as to axially and/or radially urge said slide rings towards each other and towards said housing or said shaft, with said mechanical face seal thus sealing said associated annular seal against an external environment.

2. Hydraulic torque motor in accordance with claim 1, characterized in that at the end faces of said shaft (2) one flange (4) each is arranged, having an opening (41) wherein a slide ring (5a) and an O-ring seal (6a) of said mechanical face seal is received.

3. Hydraulic torque motor in accordance with claim 2, characterized in that the inner peripheral surface of said opening (41) in said flange (4) radially widens in a direction towards said housing.

4. Hydraulic torque motor in accordance with claim 2 or 3, characterized in that said slide ring (5a) received in said flange has an outer peripheral surface (51a) radially widening in a direction towards said housing and an adjacent sliding surface (52a).

5. Hydraulic torque motor in accordance with claim 4, characterized in that said sliding surface (52a) has a substantially perpendicular orientation relative to the axis of rotation and/or radially on the inside a conical region (53a).

6. Hydraulic torque motor in accordance with any one of claims 2 to 5, characterized in that said housing contains in an axially symmetric manner equivalently formed elements, in particular an opening (11) wherein a slide ring (5b) and an O-ring seal (6b) of said mechanical face seal is received, said opening (11) radially widening in particular in a direction towards said flange, said slide ring (5b) received in said housing having an outer peripheral surface (51b) radially widening in a direction towards said flange, and an adjacent sliding surface (52b), with this sliding surface (52b) having a substantially perpendicular orientation to the axis of rotation and/or radially on the inside a conical region (53b).
